(19) United States
(12) Patent Application Publication
(10) Pub. No.: US 2022/0394960 A1
(43) Pub. Date: Dec. 15, 2022

(54) FISHING HEAD WITH RETRACTABLE BLADES FOR BOWFISHING

(71) Applicant: Justin Hughey, West Branch, MI (US)

(72) Inventor: Justin Hughey, West Branch, MI (US)

(21) Appl. No.: 17/839,477

(22) Filed: Jun. 14, 2022

Related U.S. Application Data
(60) Provisional application No. 63/209,977, filed on Jun. 12, 2021.

(51) Int. Cl. A01K 81/04; F42B 6/08

(52) U.S. Cl. CPC A01K 81/04; F42B 6/08

(57) ABSTRACT

Fisherman bowfish by using a bow with an arrow having a fishing head on an arrow. The arrow is shot at the fish using the bow, with a fishing line attached to the arrow. A tip portion of a body of the fishing head impacts the fish and movement, resulting in movement between the body and a plunger along an impact axis. This movement causes the plunger to contact blades retracted within the body, such that the blades pivot from a retracted position to an extended position. In the extended position, the blades engage the fish, such that the blades engage the fish if the fishing head is pulled backward in the direction of entry into the fish. For removal, the fishing head is pushed along the same direction of entry, which causes the blades to automatically retract.

### CROSS-REFERENCE TO RELATED APPLICATIONS

The present application is a Nonprovisional patent application, which claims priority to Provisional Patent Application No. 63/209,977, filed on Jun. 12, 2021, which is incorporated by reference in its entirety.

### TECHNICAL FIELD

The present disclosure is related to a fishing head with retractable blades for bowfishing.

### BACKGROUND

Bowfishing is a type of fishing that uses archery equipment, such as a bow or crossbow, to shoot and recover fish. The fish are shot with a barbed arrow. The barbed arrow is attached with line to a reel that is mounted on a bow or crossbow. Some types of freshwater fish that are shot include carp, grass carp, alligator gar, bighead carp, bowfin, and the like. Bowfishing may also be done in saltwater to shoot rays, sharks, etc.

### SUMMARY

Fisherman bowfish by using a bow with an arrow having a fishing head on an arrow. The arrow is shot at the fish using the bow, with a fishing line attached to the arrow. A tip portion of a body of the fishing head impacts the fish and movement, resulting in movement between the body and a plunger along an impact axis. This movement causes the plunger to contact blades retracted within the body, such that the blades pivot from a retracted position to an extended position. In the extended position, the blades engage the fish, such that the blades engage the fish if the fishing head is pulled backward in the direction of entry into the fish. For removal, the fishing head is pushed along the same direction of entry, which causes the blades to automatically retract.

### BRIEF DESCRIPTION OF THE DRAWINGS

Various features of the present invention will become more fully apparent from the following description and appended claims, taken in conjunction with the accompanying drawings. Understanding that these drawings depict only typical embodiments of the invention and are, therefore, not to be considered limiting of its scope, the embodiments of the invention will be described and explained with additional specificity and detail through the use of the accompanying drawings.

FIGS. 1 and 2 are illustrative environmental views of a fisherman bowfishing using a bow with a fishing head on an arrow.

FIG. 3 is a schematic illustrative side perspective view of a fishing head with blades in a retracted position, an intermediate position, and an extended position.

FIG. 4 is another schematic illustrative perspective view of the fishing head with the blades in the extended position.

FIG. 5 is an illustrative exploded perspective view of the fishing head.

FIG. 6 is a schematic perspective view of a blade of the fishing head.

FIG. 7 is a schematic top view of the blade of FIG. 6.

FIG. 8 is a schematic side view of an inner side of the blade.

FIG. 9 is a schematic perspective view of the plunger of the fishing head.

FIG. 10 is a schematic perspective view of a body of the fishing head.

FIG. 11 is a schematic side view of the plunger of the fishing head.

FIG. 12 is a schematic side view of the body of the fishing head.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure. Furthermore, the drawings are in simplified form and are not to precise scale. For purposes of convenience and clarity only, directional terms such as top, bottom, left, right, up, down, upper, lower, upward and downward may be used with respect to the drawings. These and similar directional terms are not to be construed to limit the scope of the disclosure in any manner. Additionally, the disclosure, as illustrated and described herein, may be practiced in the absence of any element that is not specifically disclosed herein.

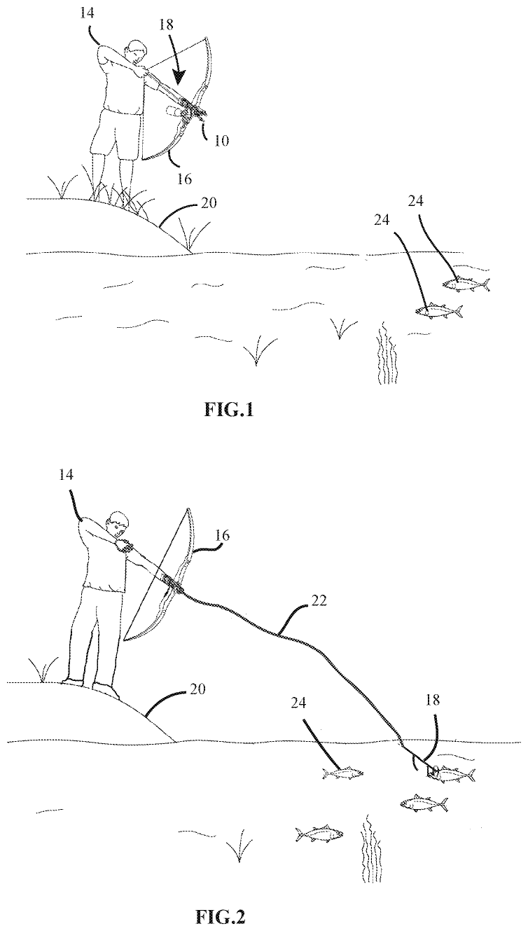

Referring to the drawings, wherein like reference numbers refer to like components throughout the several Figures, FIGS. 1 and 2 are illustrative views of a fishing head 10 of an arrow 18 being used for bowfishing by a fisherman 14. FIG. 1 illustrates the fisherman holding a bow 16 and arrow 18 on a shoreline 20 and aiming for a fish 24. FIG. 2 illustrates the fisherman 14 having shot the fish 24 with the bow 16, where the fishing head 10 of the arrow 18 pierced the fish, and the arrow 18 is tethered to the bow 16 via a fishing line 22 or otherwise tethered.

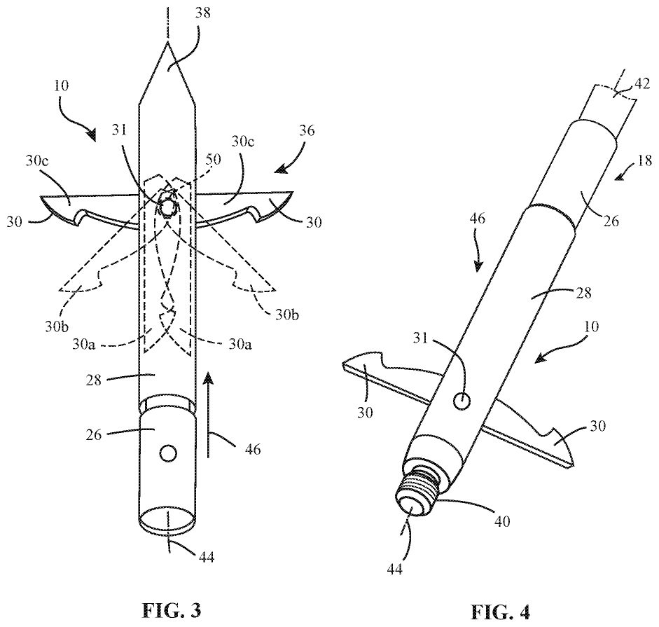

Referring now to FIG. 3, a side perspective view of the fishing head 10 is shown. The fishing head 10 includes a plunger 26, a body 28, and a pair of blades 30. As illustrated by the broken lines, the blades 30 are configured to move from a retracted position 32 (blades 30 are illustrated as 30a) through an intermediate position 34 (blades 30 are illustrated as 30b). The blades 30 eventually extend, or flare out, from the body 28 to an extended position 36 (blades illustrated as 30c in solid lines).

Referring to FIGS. 3-5, the blades 30 may be pivotally attached to the body 28 via a pin 31. The pin 31 is configured to pivotally secure the blades 30 relative to the body, such that the blades 30 pivot about the pin 31, relative to the body 28 to move from the retracted position 30a to the extended position 30c.

With continuing reference to FIG. 1, when bowhunting, the fishing head 10 is assembled with the blades 30 in the retracted position 32, and the plunger 26 at least partially slidably disposed in an end of the body 28. The fishing head 10 is configured such that the plunger 26 moves along an axis 44 (direction is indicated by arrow 46), relative to the body 28, in response to the tip portion 38 of the fishing head 10 impacting the fish 24. More specifically, when the fishing head 10 is propelled, the tip portion 38 impacts the fish 24, a force of the impact causes the plunger 26 to move within, and relative to, the body 28, along the axis 44 until the plunger 26 contacts a ramp portion 68. When the plunger 26 moves along the axis 44, the end portion 48 of the plunger 26 moves further within the body 28 and pushes against the ramp portion 68 to force the blades 30 to pivot about the pin 31, and outward relative to the body 28, from the retracted position 32 to the extended position 36. Details of this will be explained in more detail below.

A tip portion 38 may be attached to the body 28, opposite the plunger 26. The tip portion 38 may be attached to the body 28 via a treaded attachment 40 (FIG. 4), adhesive, welding, and the like. The tip portion 38 may optionally be formed with the body 28 such that the body and the tip portion 38 are a single component.

Referring now to FIG. 4, an arrow 18 is illustrated without a tip portion 38. The arrow 18 includes the fishing head 10 attached to a shaft 42.

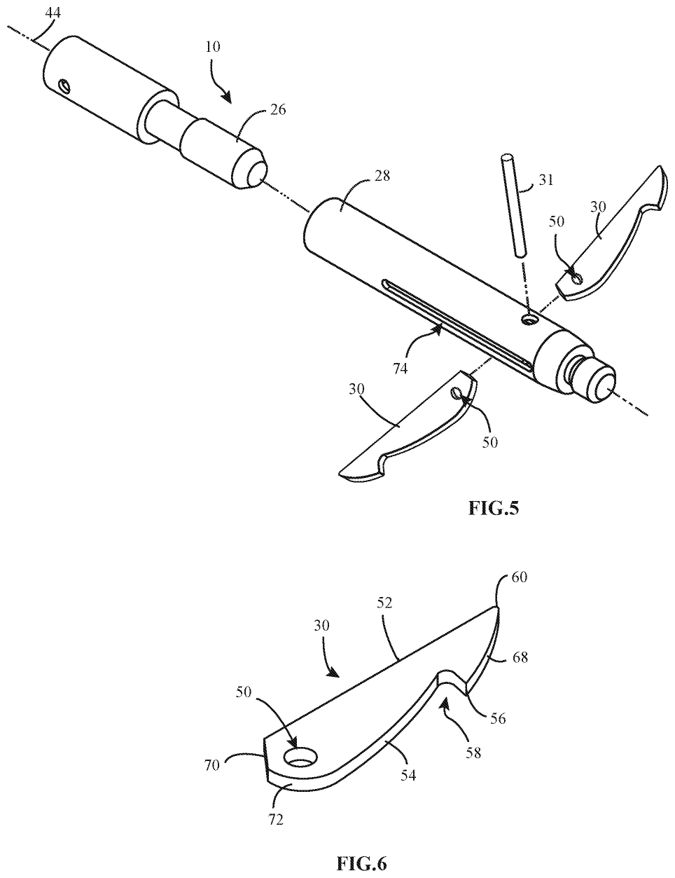

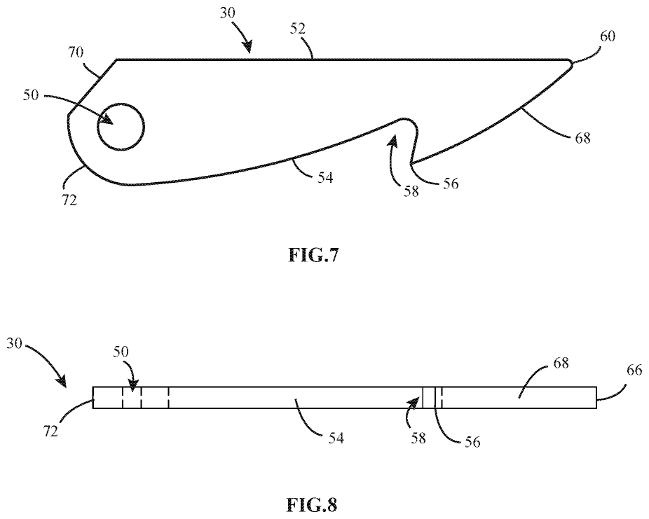

FIG. 5 is a schematic exploded view of the fishing head 10, including the plunger 26, the body 28, the pair of blades 30, and the pin 31. With specific reference to FIGS. 6, 7, and 8, the blade 30 is schematically illustrated. Each blade 30 defines a pivot hole 50 configured to receive the pin 31 therein when attached to the body 28. The blade 30 is configured with an outer edge 52 and an inner edge 54, opposite the outer edge 52. When the blade 30 is in the retracted position 32, the outer edge 52 faces outward from the body 28. The outer edge 52 is configured such that it does not cut the fish. Rather, the outer edge 52 is configured or otherwise shaped to slide directly through the fish 24 when the blades are in the retracted position 32. The inner edge 54 of the blade 30 extends from a tip portion 60 to an end portion 72. The inner edge 54 includes a barb 56 defining a V-shaped notch 58 that faces away from the tip portion 60. When the blades 30 are in the extended position 36, which is when the fishing head 10 is pushed through the fish 24, the blades 30 are configured such that inner edge 54, including the barb 56 and the inner edge 54 at the V-shaped notch 58, abuts an outside of the fish 24, or otherwise engages flesh within the fish 24, such that the fishing head 10 does not slip back out of the fish.

With reference to FIGS. 3, 11, and 12, the body 28 defines the pair of opposing slots 74, extending therethrough. The blades 30 are pivotally attached to the body 28 such that the blades 30 are recessed within a respective one of the pair of opposing slots 74 when the blades 30 are in the retracted position 32 (30a in FIG. 3) and a portion of the blades 30 extend from the respective slot 74 when the blades 30 are in the extended position 36 (30c in FIG. 3).

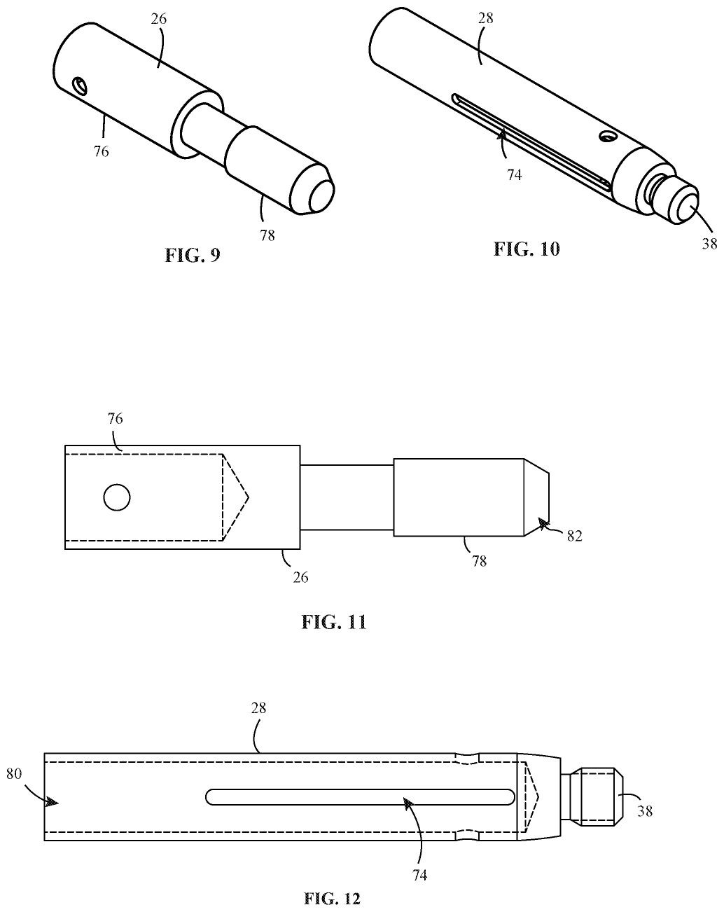

Referring now to FIGS. 9 and 10, the plunger 26 includes a first portion 76 and a second portion 78. The first portion 76 is configured for attachment to the shaft 42 of the arrow 18. The second portion 78 is configured to be received within an opening 80 defined in the body 28, opposite the tip portion 66. The second portion 78 of the plunger 26 may present an end portion 82 having a frustoconical shape, i.e., a ramped end. The end portion 82 is configured to rest against or otherwise abut the inner edgeb 54 of the blades 30, between the tip portion 66 and the barb 56, when the blades 30 are retracted. When the load is applied to the plunger 26, along the axis 44, the plunger 26 moves along the axis 44, relative to the body 28, such that the end portion 82 of the plunger 26 moves or otherwise rides along the blades 30, between the tip portion 66 and the barbs 56 to force the blades 30 to flare out from the closed position 32 to the extended position 36. As long as the plunger 26 maintains its position along the axis 44, within the body 28, the blades 30 will remain in the extended position 36 because the barbs 56 and the V-shaped notch 58 are flared beyond the slots 74, such that the V-shaped notches 58 of the blades 30 engage the body 28 to prevent the blades 30 from moving from the extended position 36 back toward the retracted position 32.

During bowfishing, the fishing head 10 is removed from the fish 24 by pushing the arrow 18 all the way through, or otherwise detaching the fishing head 10 from the shaft 42.

While the best modes for carrying out the many aspects of the present teachings have been described in detail, those familiar with the art to which these teachings relate will recognize various alternative aspects for practicing the present teachings that are within the scope of the appended claims.

1. A fishing head with retractable blades for bowfishing.
